(19) United States
(12) Patent Application Publication
(10) Pub. No.: US 2014/0184906 A1
(43) Pub. Date: Jul. 3, 2014

(54) DATA COMMUNICATION DEVICE USING VIDEO AND DATA COMMUNICATION METHOD USING VIDEO

(71) Applicant: SAMSUNG ELECTRO-MECHANICS CO., LTD., SUWON-SI (KR)

(72) Inventors: Il Kwon CHUNG, Suwon-si (KR); Kyung Joon HAN, Suwon-si (KR)

(73) Assignee: SAMSUNG ELECTRO-MECHANICS CO., LTD., Suwon-si (KR)

(21) Appl. No.: 14/142,691

(22) Filed: Dec. 27, 2013

(30) Foreign Application Priority Data
Dec. 28, 2012 (KR) 10-2012-0156864

(51) Int. Cl. H04N 7/035

(52) U.S. Cl. CPC H04N 7/035
USPC 348/465

(57) ABSTRACT

Disclosed herein is data communication that is implemented by capturing video including a plurality of different image codes and executing data matched with the image code to communicate a large amount of data while still displaying an image code for data communication in a minimum area.

### CROSS REFERENCE(S) TO RELATED APPLICATIONS

This application claims the benefit under 35 U.S.C. Section 119 of Korean Patent Application Serial No. 10-2012-0156864, entitled “Data Communication Device Using Video and Data Communication Method Using Video” filed on Dec. 28, 2012, which is hereby incorporated by reference in its entirety into this application.

### BACKGROUND OF THE INVENTION

1. Technical Field

The present invention relates to data communication, and more particularly, to a data communication device using video and a data communication method using video, for implementing data communication using video.

2. Description of the Related Art

Thus far, in order to transmit and receive data in a wired or wireless manner by different terminals, cellular communication networks such as 3 generation (3G), long term evolution (LTE), etc., or wireless LAN, Bluetooth, infrared-ray communication, visible-ray communication, etc., have been used.

Patent Document 1 below discloses a technology in which a transmitter terminal displays a coded image and a receiver terminal captures the image to perform data communication.

However, in the technology disclosed in Patent Document 1, a specific image needs to be displayed for a predetermined period of time and a greater area for displaying the coded image is required to transmit and receive a large amount of data at one time.

[Related Art Document]

[Patent Document]

(Patent Document 1) U.S. Patent Laid Open Publication No. 2010-0110088

### SUMMARY OF THE INVENTION

An object of the present invention is to provide a data communication device using video and a data communication method using video, for communication of a large amount of data while still displaying an image code for data communication in a minimum area.

According to an exemplary embodiment of the present invention, there is provided a data communication device using video, the data communication device including a first terminal for capturing video including a plurality of different image codes and executing data matched with the image codes.

The image codes may include a start identification pattern, a code pattern, and an end identification pattern.

The first terminal may include a photographing unit for capturing the video including the image codes, an image code storage unit for storing the captured image code therein, a data storage unit for storing data matched with the image codes therein, and a controller for extracting the data matched with the image codes from the data storage unit and executing the data.

The controller may include a start and end identifier for checking the start identification pattern and the end identification pattern, an image code processor for storing an image code presented between the start identification pattern and the end identification pattern of the video, in the image code storage unit, a data extractor for extracting the data matched with the image code from the data storage unit, and an executor for executing the data extracted from the data extractor.

The code pattern may include patterns obtained by modifying at least one geometrical figure to at least five types of patterns, each pattern being set to have a different code.

The code pattern may include patterns obtained by modifying the geometrical figure in six or more colors, and each pattern being set to a different code.

The geometrical figure may include a triangle, a quadrangle, and a circle.

According to another exemplary embodiment of the present invention, there is provided a data communication method using video, the data communication method including capturing video including a plurality of different image codes and executing data matched with the image codes.

The image codes may include a start identification pattern, a code pattern, and an end identification pattern.

The data communication method may further include determining whether the start identification pattern is present in the captured video after the capturing is started, capturing and storing a reproduced image code when it is determined that the start identification pattern is present, determining whether the end identification pattern is present, analyzing the stored image code and extracting data matched with the image code when it is determined that the end identification pattern is present, and executing the data extracted in the analyzing and extracting.

### BRIEF DESCRIPTION OF THE DRAWINGS

FIG. 1 is a schematic diagram of a case in which a data communication device using video is used, according to an embodiment of the present invention.

FIG. 2 is a schematic block diagram of a data communication device using video according to an embodiment of the present invention.

FIG. 3 is a schematic flowchart of a data communication method using video according to an embodiment of the present invention.

FIG. 4 is a schematic diagram showing a start identification pattern and an end identification pattern which are used in data communication using video, according to an embodiment of the present invention.

FIG. 5 is a schematic diagram showing code patterns used in data communication using video, according to an embodiment of the present invention.

### DESCRIPTION OF THE PREFERRED EMBODIMENTS

Hereinafter, advantages and features of the present invention, and technologies therefor will be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Throughout this specification, the same reference numerals in the drawings denote the same elements.

The terminology used herein is for the purpose of describing particular embodiments only and is not intended to be limiting of the inventive concept. As used herein, the singular forms “a,” “an”, and “the” are intended to include the plural forms as well, unless the context clearly indicates otherwise. It will be further understood that the terms ‘comprises’ and/or ‘comprising’ when used in this specification, specify the presence of stated elements, steps, operations, and/or devices, but do not preclude the presence or addition of one or more other features, integers, steps, operations, elements, components, and/or groups thereof.

For convenience and clarity of illustration, drawings are given in typical manners and a detailed description of known functions and configurations incorporated herein will be omitted when it may make the subject matter of the present invention unclear in the following description of the present invention. In the drawings, elements are not always illustrated on a scale. For example, some elements are for clarity of the present invention. The same reference numerals in different drawings denote the same elements and like numerals in different drawings denote like element with exception.

Throughout this specification, it will be understood that, although the terms “first”, “second”, “third”, “fourth”, etc., may be used herein to distinguish similar elements, and may be used to describe a specific order or a generating order with exception. It will be understood that such terms may be changeable in an appropriate environment such that embodiments of the present invention described herein are implemented, for example, in different sequences other than sequences illustrated or described herein. Similarly, when a method includes a series of steps, an order of the steps is not limited to an order described herein. In addition, the described step may be omitted and/or any other step may be added to the method.

Throughout this specification, it will be understood that, although the terms “left”, “right”, “front”, “behind”, “upper”, “bottom”, “above”, “below”, etc., may be used herein for explanation and may not denote an unchangeable relative position. It will be understood that such terms may be changeable in an appropriate environment such that embodiments of the present invention described herein are implemented, for example, in different directions other than directions illustrated or described herein. It will be understood that when a component is referred to as being “connected to” another component, it may be directly or indirectly connected to the other component. In addition, it will be understood that when a component is referred to as being “adjacent to” another component, it may physically contact the other component, be adjacent to the other component, or be present in the same general range or region so as to appropriately correspond to the context. Here, the term “in an embodiment of the present invention” is used to describe the same embodiment of the present invention with exception.

Hereinafter, constructions and effects of the present invention will be described with reference to the attached drawings.

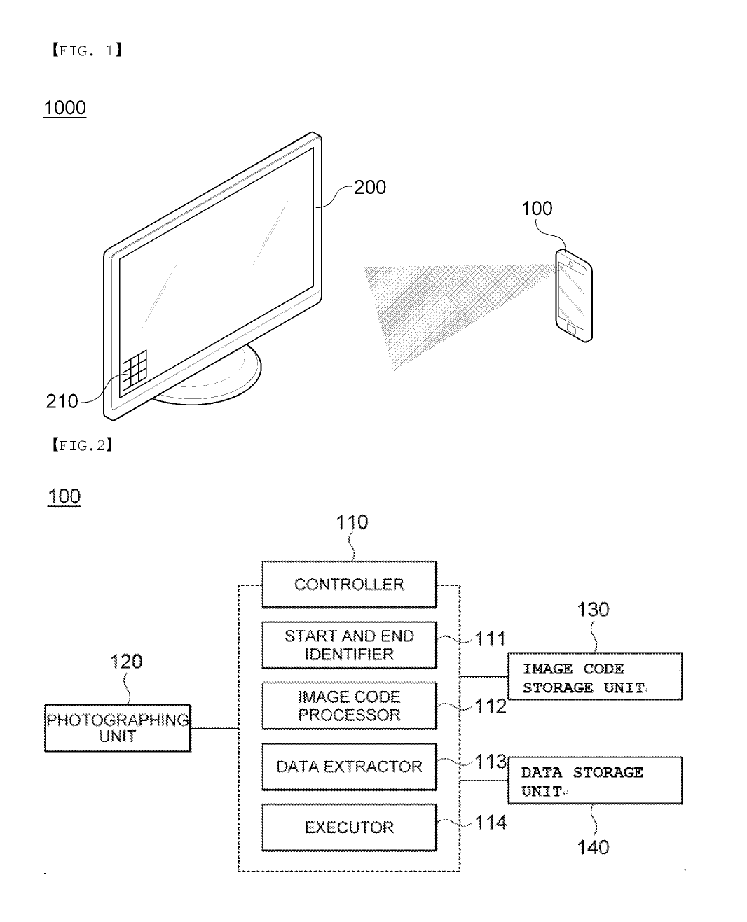

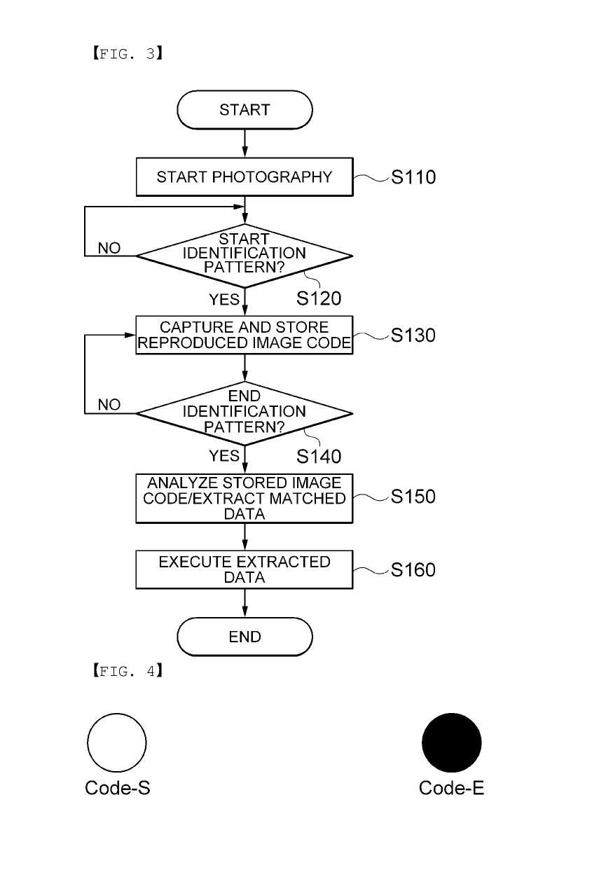

FIG. 1 is a schematic diagram of a case in which a data communication device using video is used, according to an embodiment of the present invention and FIG. 2 is a schematic block diagram of a data communication device using video according to an embodiment of the present invention.

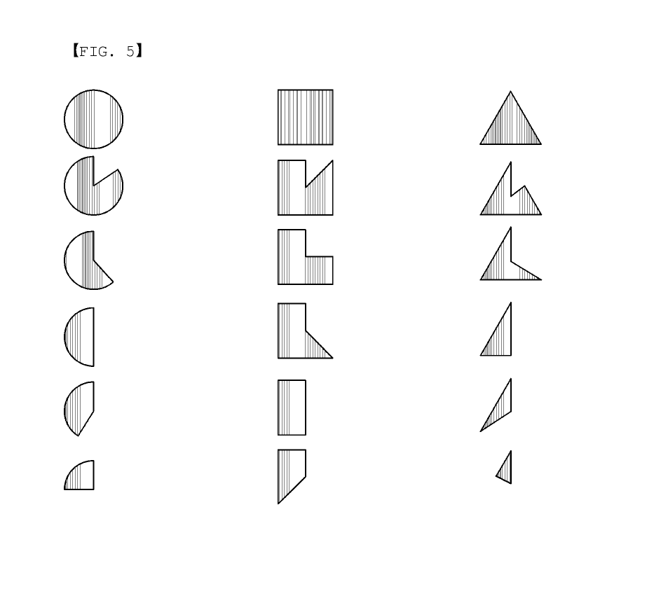

FIG. 3 is a schematic flowchart of a data communication method using video according to an embodiment of the present invention, FIG. 4 is a schematic diagram showing a start identification pattern and an end identification pattern which are used for data communication using video, according to an embodiment of the present invention, and FIG. 5 is a schematic diagram showing code patterns used in data communication using video, according to an embodiment of the present invention.

Referring to FIGS. 1 to 5, the data communication device using video according to an embodiment of the present invention includes a first terminal 100 for capturing video and executing data.

In this case, the video may be reproduced through an image code display unit 210 included in a display unit of a different terminal (shown as a second terminal 200 in FIG. 1) such as a smart phone, a tablet personal computer (PC), a notebook computer, a computer, a television (TV), a billboard, or the like.

In addition, the video may contain a plurality of different image codes.

Thus, the first terminal 100 may capture the video reproduced in the different terminal and may extract and execute data matched with the plurality of image codes contained in the video.

Referring to FIG. 2 in more detail, the first terminal 100 may include a photographing unit 120, an image code storage unit 130, a data storage unit 140, and a controller 110.

First, the photographing unit 120 may capture the video.

Then, the image code storage unit 130 may store the plurality of image codes contained in the video captured by the photographing unit 120 and may be implemented as various memory devices that are widely and typically used.

Then, the data storage unit 140 stores plural pieces of data that are set for the image codes, respectively. That is, when a specific image code is set to denote a machine language “0100100”, the data storage unit 140 may store the corresponding image code and “0100100” in conjunction with each other. In addition, the data storage unit 140 may store data and a specific command other than a machine language in conjunction with each other, if necessary.

Then, the controller 110 may control the photographing unit 120, the image code storage unit 130, and the data storage unit 140 to extract the data matched with the image codes contained in the captured video and to execute an object indicated by corresponding data.

In this case, the object indicated by data may refer to link information for access to a specific webpage, or data about a specific image or specific information and the term “execute” may refer to browse of corresponding link or display of an image or information.

The image codes may include the start identification pattern (Code-S), the code pattern, and the end identification pattern (Code-E).

Referring to FIG. 4, it will be understood that a white circle is defined as the start identification pattern (Code-S) and a black circle is defined as the end identification pattern (Code-E).

Referring to FIG. 5, the code pattern may include geometrical figures such as a circle, a triangle, a square, or the like. In addition, as shown in FIG. 5, one figure may be divided as in six or more cases.

For example, when five modified patterns may be obtained by displaying ⅚ of the circle, 4/6 of the circle, 3/6 of the circle, 2/6 of the circle, and ⅙ of the circle, the code pattern may be divided as in six cases including a case of a perfect circle is displayed.

In addition, each figure may be expressed in seven or more colors such as red, orange, yellow, green, blue, navy, purple, or the like.

Accordingly, each figure may define 42 image codes and may carry information corresponding to digital data of about 7 bits.

In addition, when it is assumed that the geometrical figure includes three types such as a circle, a triangle, and quadrangle, the geometrical figure may carry information corresponding to digital data of about 20 bits.

In addition, according to the present invention, since the video contains the plurality of different image codes, when the number of image codes contained in the video is N, the geometrical figure may carry information of 20×N bits.

When information is transferred using the video, if data is extracted by capturing the video from a center thereof, corrupted data may be extracted.

To address this problem, the start identification pattern (Code-S) and the end identification pattern (Code-E) may be contained in the image codes.

That is, data corresponding to code patterns displayed between the start identification pattern (Code-S) and the end identification pattern (Code-E) may be sequentially extracted and combined to transmit and receive complete data.

In this case, the number of code patterns displayed between start identification pattern (Code-S) and the end identification pattern (Code-E) may vary according to a running time of the video and the number of frames per second.

When the running time of the video is two prolonged, a user who captures the video may become tired or a correct image code may not be acquired due to shaking of the first terminal 100, the running time of the video needs to be reduced if possible.

In this case, in order to transmit and receive a large amount of data while reducing the running time of the video, the number of frames per second needs to be increased.

In this case, the number of frames per second may be appropriately adjusted according to performance of a display device of the second terminal 200 and performance of the photographing unit 120 of the first terminal 100. For example, when the display device of the second terminal 200 displays video of 32 frames per second, but the photographing unit 120 of the first terminal 100 recognizes video of 16 frames per second, the first terminal 100 and the second terminal 200 may reproduce an image code based on video having a maximum of 16 frames per second and may capture the video to perform data communication.

Referring back to FIG. 2, the controller 110 may include a start and end identifier 111, an image code processor 112, a data extractor 113, and an executor 114.

The start and end identifier 111 may check whether the image codes contained in the video captured by the photographing unit 120 correspond to the start identification pattern (Code-S) and the end identification pattern (Code-E).

The image code processor 112 may allow an image code presented between the start identification pattern (Code-S) and the end identification pattern (Code-E) to be stored in the image code storage unit 130.

The data extractor 113 may extract the data matched with the image code stored in the image code storage unit 130 from the data storage unit 140.

The executor 114 may execute the data extracted from the data extractor 113.

Referring to FIG. 3, the data communication method using video according to an embodiment of the present invention may include starting photography (S110), checking a start identification pattern (S120), capturing and storing an image code (S130), checking an end identification pattern (S140), extracting data (S150), and executing the data (S160).

First, the starting of the photography (S110) is a process in which a user starts capturing an image displayed on the image code display unit 210 of the second terminal 200 using the photographing unit 120 of the first terminal 100.

Then, the checking of the start identification pattern (S120) is a process for checking the presence of the start identification pattern (Code-S) while reproducing continuous images.

In this case, a next process proceeds only when the start identification pattern (Code-S) is found out.

Then, a reproduced image code is captured and stored (S130). In this case, the image code captured by the photographing unit 120 may be formed in the above-described code pattern and may be stored in the image code storage unit 130 through the start and end identifier 111.

In addition, image codes are reproduced at a predetermined number of frames per second. In this regard, the start and end identifier 111 may sequentially store such image codes that are continuously reproduced, in the image code storage unit 130.

This process may be continuously performed before the end identification pattern (Code-E) is checked.

Then, the checking of the end identification pattern (S140) is a process for checking the presence of the end identification pattern (Code-E) while reproducing the continuous images.

Then, the extracting of the data (S150) is a process for analyzing the code pattern of the image code stored in the image code storage unit 130, and searching for and extracting data matched with the corresponding code pattern from the data storage unit 140.

Lastly, the executing (S160) is a process for executing the data extracted in the extract of the data (S150).

Although not shown in drawings, the executing (S160) may be performed in conjunction with a screen display unit, a music reproducing unit, a web browser, or the like of the first terminal 100.

A detailed description of the start identification pattern (Code-S), the code pattern, the end identification pattern (Code-E), and other elements, which have been already described above, is not given here.

Thus, a large amount of data may be transmitted and received using video displayed in a very narrow region, compared with a conventional art.

The present invention having the above construction may implement communication with a large amount of data while still displaying an image code for data communication in a minimum area.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions, and substitutions should also be understood to fall within the scope of the present invention.

What is claimed is:

1. A data communication device using video, the data communication device comprising a first terminal for capturing video including a plurality of different image codes and executing data matched with the image codes.

2. The data communication device according to claim 1, wherein the image codes include a start identification pattern, a code pattern, and an end identification pattern.

3. The data communication device according to claim 2, wherein the first terminal includes:
a photographing unit for capturing the video including the image codes;
an image code storage unit for storing the captured image codes therein;
a data storage unit for storing data matched with the image codes therein; and
a controller for extracting the data matched with the image codes from the data storage unit and executing the data.

4. The data communication device according to claim 3, wherein the controller includes:
a start and end identifier for checking the start identification pattern and the end identification pattern;
an image code processor for storing an image code presented between the start identification pattern and the end identification pattern of the video, in the image code storage unit;
a data extractor for extracting the data matched with the image code from the data storage unit; and
an executor for executing the data extracted from the data extractor.

5. The data communication device according to claim 2, wherein the code pattern includes patterns obtained by modifying at least one geometrical figure to at least five types of patterns, each pattern being set to a different code.

6. The data communication device according to claim 2, wherein the code pattern includes patterns obtained by modifying the geometrical figure in six or more colors, each pattern being set to a different code.

7. The data communication device according to claim 5, wherein the code pattern includes patterns obtained by modifying the geometrical figure in six or more colors, each pattern being set to a different code.

8. The data communication device according to claim 7, wherein the geometrical figure includes a triangle, a quadrangle, and a circle.

9. A data communication method using video, the data communication method comprising capturing video including a plurality of different image codes and executing data matched with the image codes.

10. The data communication method according to claim 9, wherein the image codes include a start identification pattern, a code pattern, and an end identification pattern.

11. The data communication method according to claim 10, further comprising:
determining whether the start identification pattern is present in the captured video after the capturing is started;
capturing and storing a reproduced image code when it is determined that the start identification pattern is present;
determining whether the end identification pattern is present;
analyzing the stored image code and extracting data matched with the image code when it is determined that the end identification pattern is present; and
executing the data extracted in the analyzing and extracting.

12. The data communication method according to claim 11, wherein the code pattern includes patterns obtained by modifying at least one geometrical figure to at least five types of patterns, each pattern being set to a different code.

13. The data communication method according to claim 12, wherein the code pattern includes patterns obtained by modifying the geometrical figure in six or more colors, each pattern being set to a different code.

14. The data communication method according to claim 13, wherein the geometrical figure includes a triangle, a quadrangle, and a circle.
